(19) United States
(12) Patent Application Publication
(10) Pub. No.: US 2008/0080004 A1
(43) Pub. Date: Apr. 3, 2008

(54) Image writing system

(75) Inventors: Yoshitsugu Hirose, Kanagawa (JP); Hiroyuki Hotta, Kanagawa (JP); Minoru Koshimizu, Kanagawa (JP); Naoki Hayashi, Kanagawa (JP); Tsutomu Ishii, Kanagawa (JP); Shigehiko Sasaki, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/702,117

(22) Filed: Feb. 5, 2007

(30) Foreign Application Priority Data
Sep. 28, 2006 (JP) 2006-265308

(51) Int. Cl. G06F 12/00

(52) U.S. Cl. 358/1.17

(57) ABSTRACT

An image writing system includes a display recording medium and a writer. The display recording medium includes a storage unit that stores format information, which specifies an expression format, so that the format information is readable from an outside. The display recording medium allows the image to be written rewritably thereon in accordance with a writing external force and retains displaying of the written image even after the writing external force is removed. The writer includes a reading unit, an image generating unit and a writing unit. The reading unit reads the format information from the storage unit. The image generating unit generates an image from original image data in accordance with the read format information. The writing unit applies the writing external force to the display recording medium from which the reading unit reads the format information, to write the generated image into the display recording medium.

### CROSS-REFERENCE TO RELATED APPLICATIONS

This application is based on and claims priority under 35 U.S.C. §119 from Japanese Patent Application No. 2006-265308 filed Sep. 28, 2006.

### BACKGROUND

1. Technical Field

This invention relates to a technique of writing an image in a predetermined format onto a display recording medium, which allow an image to be formed rewritably thereon in accordance with a writing external force and which retains displaying of the formed image even after the writing external force is removed.

2. Related Art

A printed matter is generally formed by supplying a coloring material or a developing material such as ink or toner from the outside to a medium represented by a sheet of paper, to thereby provide fixed image display. A display recording medium, which allows an image to be formed rewritably thereon in accordance with a writing external force and which retains displaying of the formed image even after the writing external force is removed, has been researched and developed as a medium, which is substitution of a medium for fixedly retaining image display.

As an example, a display recording medium called electronic paper is known as a display recording medium, which allows an image to be formed rewritably thereon in accordance with a writing external force giving electronic change to the medium and which retaining displaying of the formed image even after the writing external force is removed.

Such a display recording medium is as follows. A display material for forming an image is contained in a display section as a region where image display is retained. A writing external force (electricity, magnetism, heat or chemical action of liquid at predetermined PH) is made to act on the display material, to there by physically or chemically change a state of the display material and form an image according to the writing external force. The formed image is maintained even after the writing external force is removed. Furthermore, if a different writing external force is applied, the previous image changes to an image according to the new writing external force. Thus, the medium is often called electronic paper because the display image is rewritten without supplying a coloring material or a developing material from the outside is like an electronic device in addition to the fact that maintaining (storage) of the display state with the writing external force removed is like paper.

The display recording medium called electronic paper usually has a storage unit integral with a display section. For example, electronic information of an identification code of the medium is stored in the storage units readably from the outside and may be used for image writing control.

Also, it is presumed that such a display recording medium is used as a display medium like paper that can be repeatedly for use in writing. Therefore, the display recording medium usually does not include a display rewriting function as the medium alone. An image is written by setting the display recording medium in a writer for allowing replacement of a display recording medium to be rewritten. The display recording medium onto which an image is written is detached from the writer and is provided to a user to view the written and formed image.

By the way, when an image is printed on a paper medium with a printer from a computer, some printer changes an output size, which was set in advance at the time when the image was written, to a user's desired size or automatically enlarges/reduces the image in accordance with an original size of the image and a size of the paper medium.

Also, when a dot matrix display is performed on an image display such as a liquid crystal panel where a displayed image is electrically updated at all times unlike a paper medium, image dots and display pixels are caused to have a one-to-one correspondence relation and a part that lies outside of a screen is displayed by scrolling that part or by scaling up or down the display image size.

### SUMMARY

To write an image onto the display recording media described above, although the display format can be set and the display format corresponding to the medium size and the like can also be automatically set by the writer as in printing onto a paper medium, not enough study has been made on a process of writing an image onto a display recording medium.

In view of the above circumstances, the invention has been made and utilizes a function of a display recording medium to write an image onto the display recording medium in a predetermined expression format such as a format corresponding to the display recording medium or its user, or a format corresponding to a display performance of the display recording medium.

According to an aspect of the invention, an image writing system includes a display recording medium and a writer. The display recording medium includes a storage unit that stores format information, which specifies an expression format of an image written into the display recording medium, so that the format information is readable from an outside of the display recording medium. The display recording medium allows the image to be written rewritably thereon in accordance with a writing external force and retains displaying of the written image even after the writing external force is removed. The writer includes a reading unit, an image generating unit and a writing unit. The reading unit reads the format information from the storage unit. The image generating unit generates an image from original image data in accordance with the read format information. The writing unit applies the writing external force to the display recording medium from which the reading unit reads the format information, to write the generated image into the display recording medium.

### BRIEF DESCRIPTION OF THE DRAWINGS

Exemplary embodiments of the invention will be described in detail below with reference to the accompanying drawings wherein:

FIG. 1 is a block diagram to show the configuration of an image writing system according to an exemplary embodiment of the invention;

FIG. 2 is a drawing to describe identification information according to the exemplary embodiment of the invention; and

FIG. 3 is a drawing to describe the image writing system according to the exemplary embodiment of the invention.

### DETAILED DESCRIPTION

Exemplary embodiments of the invention will be described.

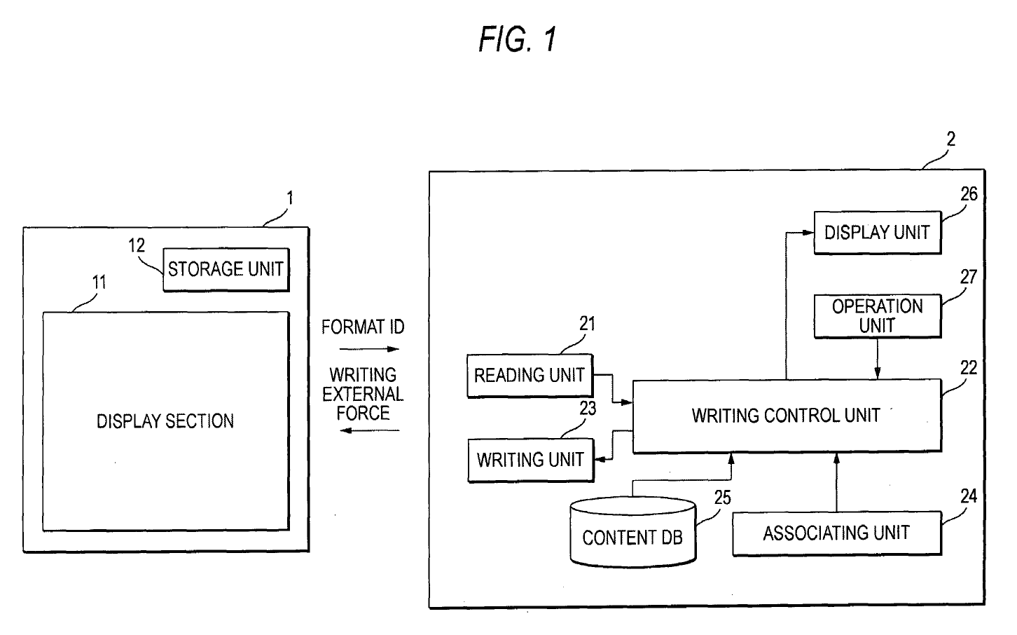

FIG. 1 shows the configuration of an image writing system according to an exemplary embodiment of the invention.

The image writing system includes: a display recording medium 1, which allows an image to be formed rewritably thereon in accordance with a writing external force and which retains displaying of the formed image even after the writing external force is removed; and a writer 2, which applies the writing external force to the display recording medium 1 so as to write an image onto the display recording medium 1.

The display recording medium 1 includes: a display section 11 that retains the displaying of the written image; and a storage unit 12 that stores format information, which specifies an expression format of the written image, so that the format information is readable from the outside.

The display recording medium 1 is a thin and flexible device like paper. Any of various modes of the display section 11 may be adopted in response to the write method. The display section 11 may be one, which is driven by directly applying an external force such as electricity, magnetism, or heat. The display section 11 may adopt the display principle of driving elements in a chain-reaction manner. For example, the display section 11 may be one, which is driven by voltage change accompanied by light application, or one, which changes the color presentation state in accordance with PH change of liquid accompanied by voltage application. A full rewriting mode, a line rewriting mode by moving a recording head, or an electric scan rewriting mode by a simple matrix driving or an active matrix driving may be adopted.

For example, the display section 11 adopting a method of electrically writing an image has the following structure. Fine colored charged particles are filled between a pair of front and rear matrix electrodes. At least the front matrix electrode is transparent. The fine color charged particles, the pair of front and rear matrix electrodes are sandwiched between a pair of front and rear film substrates. At least the front film substrate is transparent. When a positive voltage or a negative voltage is applied to the electrode, black colored particles and white colored particles remain on the respective opposite faces (the front face and the rear face) of the display medium.

Therefore, when no voltage is applied to the electrode (no power supply state), the negatively charged white particles remain on the rear side while the positively charged black particles remain on the front side. As a result, if the display section 11 is viewed from the front side, the display section 11 displays a black color. When a polarity of a required portion of the electrode in the matrix is inverted in accordance with an image, which is displayed based on electronic data, the positional relationship between the white particles and the black particles is switched and an image based on the contrast between the white particles and the black particles is displayed. If the matrix electrode is operated based on different electronic data, the image displayed based on the contrast between the white particles and the black particles can be switched and the display recording medium can be reused repeatedly.

Also, for example, the display section 11 adopting a method of optically writing an image has the following structure. A layer of organic photoconductive material (organic photoconductive layer) used in a copier and a layer of liquid crystal display material (cholesteric liquid crystal layer put into microcapsules) are used in combination. These layers are sandwiched between a pair of front and rear transparent electrodes. This layered body is sandwiched between a pair of front and rear transparent substrate films. An image to be transferred to a dimming element panel for image writing (light emission panel) is displayed and is projected on the display section 11. When a voltage is applied to the electrode, intensity of light is converted into the reflection density in a moment, and the projected image is retained even after the voltage is removed. When an erasing voltage is applied to the electrode, the retained image can be erased and the display recording medium can be used repeatedly while writing and erasing are repeated.

The storage unit 12 can adopt any of various modes in accordance with a method for reading stored information.

For example, the storage unit 12 may have: a memory that stores format information, which specifies an expression format of a written image, as electronic data; and a transmission function of transmitting the electronic data stored in the memory in response to access from an external device via wireless or wire connection.

Also, for example, the storage unit 12 may be a bar code tape on which encoded format information is printed, and the bar code tape may be read optically.

The storage unit 12 may further store any other information such as a medium identification code and a user identification code, in addition to the format information.

The format information which is stored in the storage unit 12 and which specifies the expression format of a written image may be information representing a format corresponding to the display performance of the display section 11 of the display recording medium 1 or information representing a display format set by a user in advance. In other words, the format information is information used to determine the appearance of an image when original data forming the image is expressed on the display section 11 of the display recording medium 1. The format information is different from a file format used to specify the data internal structure of an electronic file.

As the format corresponding to the display performance of the display section 11, the image display performance of the display recording medium 1 such as a size of the display section 11, a resolution of the display section 11, and a color displaying availability of the display section 11 may be adopted.

A process condition of a display image, which can be specified by a user desirably about the image display format, as the display format set by a user in advance. For example, the process condition may include any of specification of a display magnification of an image, specification of writing and displaying images of plural pages in a single image collectively, and specification of displaying a color image as a monochrome image.

The “user” mentioned here contains not only a user who views the display recording medium 1, but also a user who allows the display recording medium 1 to be used. That is, the format information may be set by at least any of the persons, who use this system, containing not only the viewer, but also the provider of the display recording medium 1 and display information.

The storage unit 12 may be a non-volatile memory so that the format information stored in the storage unit 12 is unrewritable, or may be a flash memory so that the format information stored in the storage unit 12 is rewritable.

Particularly, if the viewer is allowed to set the format information, this system is configured so that the user sets the format and writes the format information into the storage unit 12 through the writer 2 or a format information setting unit, such as a computer, which has an access unit for accessing the storage unit 12 via wired or wireless communication.

On the other hand, if a party who provides the display recording medium 1 or information sets the format information, it is prohibited or limited to rewrite the format information.

When it is prohibited or limited to rewrite the format information, the format information setting unit (e.g. a personal computer) may be configured so as to acquire both or either of the medium ID from the display recording medium 1 and the user ID of the person who attempts to change the format information from a user ID acquiring unit, and to authenticate the person before executing rewriting of the format information.

When a large number of display record media 1 are used like paper, it takes much time to make the same setting for respective media one by one. Therefore, the format information setting unit (e.g., a personal computer) may set information about a display format, which is not affected by the display performance of the media, and the format information is used to write into the storage unit 12 of the display record media 1 subsequently.

The display recording medium 1 is used with the format information being stored in the storage unit 12 in advance. The format information stored in the storage unit 12 may be both or either of the format information relating to the display performance and the format information set by the user. Different types of format information such as a size of the display section 11 and a resolution of the display section 11, for example, may be set.

Actual data, which is an entity of the format information, may be recorded in the storage unit 12, and the writer 2 may read the actual data. Alternatively, the writer 2 may includes an associating unit 24 such as a table in which the actual data of the format information and identification information for identifying the format information are associated with each other, the identification information corresponding to the actual data of the format information may be recorded in the storage unit 12, and the write 2 may read the identification information from the display recording medium 1.

The writer 2 includes: a reading unit 21 for reading the format information from the storage unit 12 of the display recording medium 1; a writing control unit (image generating unit) 22 for generating a content image in accordance with the read format information; a writing unit 23 for applying a writing external force to the display recording medium 1 from which the format information is read so as to write the generated content image; and a format information setting unit (not shown) for rewriting items of the format information in the storage unit 12 that can be set by the user.

The writer 2 according to this exemplary embodiment shown in FIG. 1 further includes: a content database 25 storing content data of images to be written; a display unit 26 for displaying various pieces of information required for the writing operation of an operator on a screen; and an operation unit 27 for accepting various operation entries for the writing control unit 22 from the operator.

The reading unit 21 reads the format information stored in the storage unit 12 and inputs the format information into the writing control unit 22.

As the reading unit 21, any of various types may be adopted in accordance with the mode of the storage unit 12. For example, if the storage unit 12 is one, which can be accessed in a wireless manner like an IC tag, the reading unit 21 may be a wireless access device for transmitting an access radio wave in a predetermined range in the vicinity of the reading unit 21 so as to excite the storage unit 12 in the range and to read information stored in the storage unit 12 in a non-contact manner. Alternatively, if the storage unit 12 is a memory having a reading terminal, the reading unit 21 may be a reader having an access terminal, which is connectable to the read terminal and which reads information stored in the storage unit 12. Further alternatively, if the storage unit 12 is a code tape on which encoded format information is printed, the reading unit 21 may be a reader for optically reading the code and converting the code into information.

The writing control unit 22 acquires from the content database 25 the content image data to be written onto the display recording medium 1 from which the format information is read and which is selected according to a command entered through the operation unit 27. Then, the writing control unit 22 generates image data so that a content image is expressed on the display section 11 with an appearance corresponding to the read format information.

That is, in this exemplary embodiment shown in FIG. 1, the writing control unit 22 references the associating unit 24 and generates image data in the expression format corresponding to the display performance or the layout specified by the format information.

The writing unit 23 applies a writing external force to the display section 11 of the display recording medium 1 from which the format information is read so as to write the image generated by the writing control unit 22.

As the writing unit 23, any of various types may be adopted in accordance with the mode of the display section 11. For example, if the display section 11 adopts a mode in which an image is written according to light, which retains and displays a projected image, the writing unit 23 may be a device for applying an external force, that is, applying a writing voltage and projecting an image to the display section 11. When the writing unit 12 applies the writing voltage and projects the image to the display section 11, the image is written into the display section 11. Alternatively, if the display section 11 adopts a mode in which an image is electrically written by applying voltage in accordance with image data between matrix electrodes where colored particles are filled, the writing unit 23 may be a device for applying an external force, that is, image data to a driver provided in the display section 11 to drive the matrix electrodes. Thus, the writing unit 23 can write an image into the display section 11 in accordance with data of the image to be written.

It is desirable that the display recording medium 1 based on a matrix electrode driving should have a lightweight, inexpensive, and small power consumption configuration. Therefore, the writing control unit 22 may generate raster data (bit map image data) to be displayed on the display section 11 as image data and the driver provided in the display section 11 may perform only selection driving of the matrix electrodes. Alternatively, if the raster data is compressed and is sent for decreasing an amount of the data communication from the writer 2, the display section 11 may decode the compressed data, which requires small load as compared with image expansion.

The functions of at least the reading unit 21, the writing control unit 22, and the writing unit 23 of the writer 2 may be implemented as a program is executed in a computer. Also, the writer 2 may be implemented by computer hardware.

In this exemplary embodiment shown in FIG. 1, the format information is stored in the storage unit 12 as identification information. Thus, the writer 2 includes the associating unit 24 having a table in which the identification information and the actual data of the format information are associated with each other. The writing control unit 22 references the associating unit 24 to determine the actual data of the format information from the identification information read from the display recording medium 1, and generates an image to be expressed on the display section 11 in accordance with the determined format information.

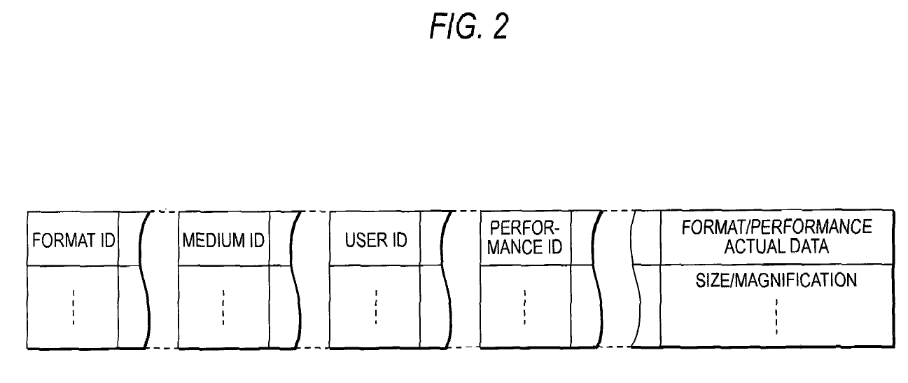

In the associating unit 24, for example, as shown in FIG. 2, a format ID, a medium ID, a user ID and a performance ID are used as the identification information of the format information. The format ID uniquely identifies the display format of an image to be written. The medium ID uniquely identifies each display recording medium. The user ID uniquely identifies each user. The performance ID uniquely identifies the display performance of the display recording medium. The actual data of the format information is set in association with the identification information.

The format ID is identification information for identifying the general format of a display image, such as the image size, font, and color. The actual data required to generate an image in the format, which is set correspondingly to the format ID, is described in the table.

The medium ID is identification information for identifying each display recording medium 1. The actual data required to generate an image in the format, which is set for each display recording medium in advance, is described in the table.

The user ID is identification information for identifying the user of the display recording medium 1. The actual data required to generate an image in the format, which is set for each user in advance, is described in the table.

The performance ID is identification information for identifying the display performance of the display recording medium 1. The actual data required to generate an image in the format, which is set for each display recording medium in advance, is described in the table.

That is, the writing control unit 22 references the associating unit 24 with using the read identification information of the format ID to thereby acquire the actual data of the format information corresponding to the identification information, and generates the image to be written onto the display recording medium 1 in the format corresponding to the identification information.

The format ID, the medium ID, the user ID and the performance ID may be set as desired in accordance with the type of format information. The format information may be determined according to a combination of different pieces of the identification information to generate an image.

The associating unit 24 may be provided outside the writer 2 so that the writing control unit 22 acquires the actual data from the associating unit 24 by network access, if necessary.

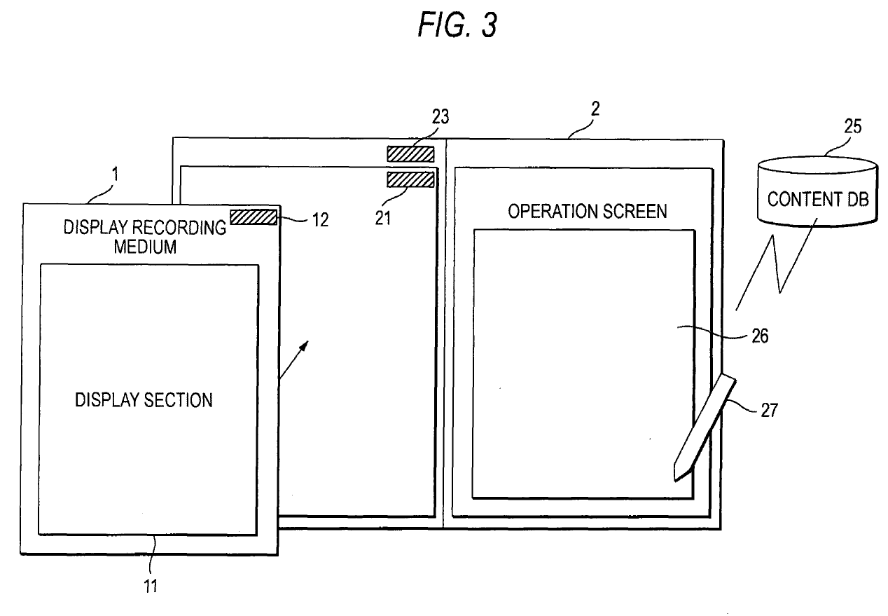

FIG. 3 shows a specific example of the image writing system according to an exemplary embodiment of the invention.

The writer 2 shown in FIG. 3 is a binder-type device to which a display recording medium 1 onto which an image is electrically written is attached in a detachable manner. The writer 2 has a function of acquiring content image data to be written from an external content database 25 by executing wireless communications.

The writer 2 includes the reading unit 21 and the writing unit 23 on one face of the binder on which a display recording medium 1 is placed. The writer 26 also includes a touch panel display unit 26 for displaying information required for the operator on a screen and an operation unit 27 for accepting operation input as the operator brings a pen into contact with the screen 26 on an opposite face of the binder.

In this image writing system, when a display recording medium 1 is attached to the writer 2, the storage unit 12 and the reading unit 21 are connected and the writing unit 23 is connected to a writing terminal (not shown) of the display recording medium 1.

In this state, when the operator enters a writing start command into the writer 2, the reading unit 21 reads format information from the storage unit 12, the writing control unit 22 acquires required content image data from the content database 25 and generates image data of the content image in the format specified by the read format information, and the writing unit 23 drives the display section 11 from the write terminal according to the generated image data so as to display and retain the generated image on the display section 11.

### FIG. 1

11 DISPLAY SECTION
12 STORAGE UNIT
21 READING UNIT
22 WRITING CONTROL UNIT
23 WRITING UNIT
24 ASSOCIATING UNIT
25 CONTENT DB
26 DISPLAY UNIT
(A) FORMAT ID
(B) WRITING EXTERNAL FORCE

### FIG. 2

(A) FORMAT ID
(B) MEDIUM ID
(C) USER ID
(D) PERFORMANCE ID
(E) FORMAT/PERFORMANCE ACTUAL DATA
(F) SIZE/MAGNIFICATION

### FIG. 3

1 DISPLAY RECORDING MEDIUM
11 DISPLAY SECTION
25 CONTENT DB
26 OPERATION SCREEN

What is claimed is:

1. An image writing system comprising:
a display recording medium comprising:
a storage unit that stores format information, which specifies an expression format of an image written into the display recording medium, so that the format information is readable from an outside of the display recording medium, wherein the display recording medium allows the image to be written rewritably thereon in accordance with a writing external force and retains displaying of the written image even after the writing external force is removed; and
a writer comprising:
a reading unit that reads the format information from the storage unit;
an image generating unit that generates an image from original image data in accordance with the read format information; and
a writing unit that applies the writing external force to the display recording medium from which the reading unit reads the format information, to write the generated image into the display recording medium.

2. The system according to claim 1, wherein:
the format information specifies the expression format corresponding to a display performance of the display recording medium, and
the image generating unit generates the image in the expression format specified by the read format information.

3. The system according to claim 1, wherein:
the format information specifies the expression format, which is set by a user in advance, and
the image generating unit generates the image in the expression format specified by the read format information.

4. An image writing system comprising:
a display recording medium comprising:
a storage unit that stores identification information so that the identification information is readable from an outside of the display recording medium; and
a writer comprising:
a reading unit that reads the identification information from the storage unit;
an associating unit that outputs format information associated with the read identification information, wherein the format information specifies an expression format;
an image generating unit that generates an image from original image data in accordance with the output format information; and
a writing unit that applies a writing external force to the display recording medium from which the reading unit reads the identification information, to write the generated image into the display recording medium, wherein:
the display recording medium allows the image to be written rewritably thereon in accordance with the writing external force and retains displaying of the written image even after the writing external force is removed.

5. The system according to claim 4, wherein the associating unit stores a table in which plural pieces of identification information are associated with plural pieces of format information, respectively.

6. The system according to claim 5, wherein the plural pieces of format information specify the respective expression formats corresponding to display performances of the display recording mediums.

7. The system according to claim 5, wherein the plural pieces of format information specify the respective expression formats, which are set by a user in advance.

8. A writer having:
a reading unit that reads format information from a storage unit of a display recording medium, wherein the format information specifies an expression format of an image written into the display recording medium;
an image generating unit that generates an image from original image data in accordance with the read format information; and
a writing unit that applies a writing external force to the display recording medium from which the reading unit reads the format information, to write the generated image into the display recording medium, wherein:
the display recording medium allows the image to be written rewritably thereon in accordance with the writing external force and retains displaying of the written image even after the writing external force is removed.

9. A display recording medium has:
a display section that allows an image to be formed rewritably thereon in accordance with a writing external force, the display section that retains displaying of the formed image even after the writing external force is removed; and
a storage unit that stores format information, which specifies an expression format of an image written into the display recording medium, so that the format information is readable from a writer, wherein:
the writer applies the writing external force to the display recording medium to write an image having the expression format specified by the format information, onto the display recording medium.

10. A computer readable medium storing a program causing a computer to execute a process for writing an image into a display recording medium, the process comprising:
reading format information from the display recording medium, wherein the format information specifies an expression format of an image written into the display recording medium;
generating an image from original image data in accordance with the read format information; and
applying a writing external force to the display recording medium from which the format information is read, to write the generated image into the display recording medium, wherein:
the display recording medium allows the image to be written rewritably thereon in accordance with the writing external force and retains displaying of the written image even after the writing external force is removed.
